(19) United States
(12) Patent Application Publication
(10) Pub. No.: US 2007/0184735 A1
(43) Pub. Date: Aug. 9, 2007

(54) Filament-reinforced adhesive tape

(75) Inventors: Petra Yun, Hamburg (DE); Ralf Schliephacke, Itzehoe (DE); Norbert Grittner, Hamburg (DE); Michael Schwertfeger, Hamburg (DE); Ulrich Otten, Hamburg (DE)

Correspondence Address: Kurt G. Briscoe;Norris, McLaughlin & Marcus P.A., 18th Floor, 875 Third Avenue, New York, NY, 10022, US

(73) Assignee: tesa AG, Hamburg (DE)

(21) Appl. No.: 11/378,964

(22) Filed: Mar. 17, 2006

(30) Foreign Application Priority Data
Feb. 7, 2006 (DE) 20 2006 002 019.5

(51) Int. Cl. B32B 27/04; B32B 7/12

(52) U.S. Cl. 442/149; 428/343

(57) ABSTRACT

Adhesive tape having a backing which comprise integrated fibers or filaments for added strength, the cut edge of which is serrated.

The invention relates to a filament-reinforced adhesive tape.

In connection with the processing of fabrics it has been known for a long time that individual fibres can be prevented from pulling out by cutting the fabric not linearly but instead in zigzag form. As a result of this, the threads parallel to the cut edge are severed transversely at regular intervals and cannot be extracted in a longer piece. Short thread fragments that fall out tend to disrupt subsequent processing to a significantly lesser extent than do long threads, and are therefore accepted. It is for this reason that the literature has disclosed numerous devices which produce such serrations.

Another method of preventing fibre pullout is to carry out thermal welding of the fabric during or after cutting. However, this can be utilized only with thermoplastic materials such as polyester, nylon or polypropylene, but not, for example, with natural fibres, glass or Kevlar.

However, where fabrics are fixed by means of coating, impregnation, or thermally, the risk of fibre pullout no longer exists, or only to an insignificant extent, and so countermeasures such as serration are not practised.

As well as for preventing fibre pullout, serration may likewise be utilized with advantage in order to improve the hand tearability of fabrics. The majority of fabrics resist attempts to tear into them by hand, owing to the strength of the individual fibres and the fabric's flexibility, to such an extent that tearing in at a straight cut edge by hand is well-nigh impossible or can be achieved only with great effort. Since, however, this hand tearability is desirable in the case of frequent use of, for example, plasters in roll form or pressure-sensitive adhesive tapes, in order to facilitate handling, serration can be employed with advantage here as well. In this case the tear always starts from the peak of a serration directed away from the cut edge. Once it has been begun, the tear can usually be continued without great effort in dense fabrics, parallel to warp or weft depending on the direction of cut.

This technique for achieving hand tearability in fabrics has the disadvantage, however, that the tensile strength of such a material is greatly reduced. The reason for this is that, under high load, the start of tears, as described, is favoured at the serration peaks directed away from the cut edge, and the force for continuation of the tear (tear propagation force) is substantially lower than the force needed to generate a tear at the fabric edge or in the fabric (in-tear force). In many cases this disadvantage can be accepted, as in the case, for example, of the roll plasters mentioned above.

With film-based materials as well, serration may be employed with advantage for the same reasons—as, for example, in the case of double-sided adhesive tapes for fixing carpets. DE 43 18 277 C1 discloses the use of serrated knives for lengthwise cutting of double-sided self-adhesive tapes with PP backings, which find use in particular as carpetlaying tape.

The serrations of the serrated cutter preferably have a height of 0.3 to 6 mm, especially 0.4 to 1 mm. The resultant serrature of the cut edge increases the hand tearability of the adhesive tape.

Backings used in the area of (self-)adhesive tapes include not only those materials based on polymeric films and paper but also those based on woven and nonwoven fabrics. The area of the woven fabrics also encompasses, in a wider sense, fabrics which, in the form of what are called filament adhesive tapes, comprise a backing material which is composed of an optional support film and of non-folded and non-tangled or folded or tangled filaments integrated in the lengthwise direction, or else of an optional support film and an open, woven or laid fabric composed of non-folded and non-tangled or folded or tangled filaments. The filaments are generally composed of high-strength fibres of low breaking extension, such as glass fibres, for example, or else of drawn polymer fibres such as polyester fibres, polypropylene fibres, polyethylene fibres, polyamide fibres or aramid fibres.

The risk of fibre pullout with these filament adhesive tapes is particularly great when the filaments used are located directly at the cut edge and are therefore severed in the lengthwise direction, and when the filaments, owing to the individual fibres lying parallel and close to one another in the filaments, are not fully impregnated by pressure-sensitive adhesive or other coatings. As a consequence, in the centre of the filaments, individual fibres are often loose and unbonded, and, if the filament is severed in parallel of the cut edge, they can easily fall out, particularly when the filaments in question are neither spun nor folded nor tangled filaments.

The individual fibres which have fallen out may subsequently wind themselves easily around rotating shafts and other web guidance elements on continuous processing machines, and may ultimately lead to considerable cleaning cost and effort, adhesive tape tears, or even to production standstill. For economic reasons, however, this is unacceptable and would rule out the possibility of using filament adhesive tapes of this kind in continuous operations.

At the same time, when seeking for measures to counter the above-described fibre pullout, it must be borne in mind that the said self-adhesive filament tapes are employed particularly when there is a need for particularly high tensile strength in tandem with particularly low stretchability. Therefore the tensile strength must be largely maintained under all circumstances. Nor is a reduction in the in-tear force or in the tear propagation force acceptable, since that would run counter to the purpose of the adhesive tape.

DE 102 23 631 A1 discloses an adhesive tape having a film backing material in which a tear can be propagated transversely with respect to the direction from which individual lengths of the tape are taken, an adhesive being applied to one side of said backing material, with an adhesive weight per unit area of at least 40 g/m², and there being on the other side, opposite the adhesive, a release, one or both longitudinal edges of the adhesive tape having notches over the entire area, with a width of less than 1000 μm and a depth of less than 100 μm, the notches being disposed irregularly and differing in depth. DE 102 23 632 A1 describes the use of an adhesive tape for masking during painting and decorating applications, having a film backing material in which a tear can be propagated transversely with respect to the direction from which individual lengths of the tape are taken, on one side of said backing material an adhesive has been applied, the adhesive tape being coloured and/or non-transparent and one or both longitudinal edges of the adhesive tape having over the entire area notches having a width of less than 1000 μm and a depth of less than 100 μm, the notches being irregularly disposed and of differing depth.

DE 102 23 634 A1 discloses an adhesive tape having a film backing material in which a tear can be propagated transversely with respect to the direction from which individual lengths of the tape are taken, an adhesive being applied to one or both sides of said backing material, and one of the two longitudinal edges having a rough cut edge such that over the entire area there are notches in a frequency of at least 1/mm, the notches being disposed irregularly and differing in depth, and the other longitudinal edge being substantially smooth and having no such notches or a greatly reduced number thereof.

FR 1,522,942 A discloses a relevant adhesive tape one edge of which has microscopic notches.

It is an object of the invention, therefore, to avoid fibre pullout from fibre- or filament-reinforced adhesive tapes without substantial reduction in tensile strength.

This object is achieved by means of an adhesive tape as laid down in the main claim. The dependent claims provide advantageous developments of the adhesive tape.

The invention accordingly provides an adhesive tape having a backing material applied to at least one side of which is an adhesive and whose strength in lengthwise direction is reinforced by integrated fibres or filaments, where the adhesive tape on at least one long edge has incisions, in particular a serration, the incisions or serration severing per long edge not more than one filament aligned substantially parallel to the cut edge.

For the purposes of this invention the term “filament” refers to a bundle of individual, parallel, linear fibres, often referred to as multifilament in the literature. Where appropriate, this fibre bundle may be given inherent strengthening by torsion, and is then referred to as spun or folded filament. Alternatively the fibre bundle can be given inherent strengthening by entangling using compressed air or water jets. In the text below, for all these embodiments—and also for the fibre-reinforced embodiment—only the term “filament” will be used, in a generalizing way.

Where the backing material is reinforced exclusively by filaments integrated in lengthwise direction, the resulting adhesive tapes are referred to as monofilament tapes. In one advantageous development of the subject matter of the invention the backing material is reinforced by an open filament fabric. In this case the adhesive tape is referred to as a cross-woven filament tape.

Suitable backing materials include laminates, films (for example BOPP, MOPP, PP, PE, PET, PA, PU, PVC), foams, and foamed or metallized films. The films themselves may in turn be composed of two or more individual layers—for example, layers coextruded to a film.

Preference is given to polyolefins, although copolymers of ethylene and polar monomers such as styrene, vinyl acetate, methyl methacrylate, butyl acrylate or acrylic acid are also included. The polymer may be a homopolymer such as HDPE, LDPE, MDPE or a copolymer of ethylene with a further olefin such as propene, butene, hexene or octene (for example LLDPE, VLDPE). Also suitable are polypropylenes (for example polypropylene homopolymers, random polypropylene copolymers or block polypropylene copolymers).

The film may be unoriented.

Outstandingly suitable for use as films in accordance with the invention are monoaxially and biaxially oriented films. Monoaxially oriented polypropylene, for example, is notable for its very high breaking strength and low extension in lengthwise direction, and is used, for example, to produce strapping tapes. Monoaxially oriented films based on polypropylene are possible.

Particular preference is given to films based on polyester.

The backing material preferably has an extension of less than 10% under a load of 10 N/cm and also a basis weight of less than 350 g/m², preferably less than 200 g/m², more preferably less than 150 g/m².

With further preference the backing material exhibits an ultimate tensile stress extension of below 25%, preferably below 15%, more preferably below 10%.

In one particularly advantageous embodiment of the invention the backing material has a thickness of 10 to 100 μm, in particular of 20 to 40 μm.

The films may be coloured and/or transparent.

The adhesive of the adhesive tapes of the invention may be a (self-)adhesive from the group of the natural rubbers or synthetic rubbers, or composed of any desired blend of natural rubbers and/or synthetic rubbers, it being possible for the natural rubber or rubbers to be selected in principle from all available grades such as, for example, crepe, RSS, ADS, TSR or CV grades, depending on required purity and viscosity level, and for the synthetic rubber or rubbers to be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible to improve the processing properties of the rubbers by adding thermoplastic elastomers with a weight fraction of 10% to 50% by weight, based on the total elastomer fraction.

Representatives that may be mentioned at this point include in particular the especially compatible styrene-isoprene-styrene (S IS) and styrene-butadiene-styrene (SBS) grades.

In addition, a 100% system based on styrene-isoprene-styrene (SIS) has proved to be suitable.

Tackifying resins which can be used include without exception all tackifier resins already known and described in the literature. Representatives that may be mentioned include the rosins, their disproportionated, hydrogenated, polymerized and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Explicit reference may be made to the depiction of the state of knowledge in the “Handbook of Pressure Sensitive Adhesive Technology” by Donatas Satas (van Nostrand, 1989).

Crosslinking is advantageous for improving the removability of the adhesive tape after the application, and may take place thermally or by irradiation with UV light or electron beams.

For the purpose of thermally induced chemical crosslinking it is possible to employ all known thermally activable chemical crosslinkers, such as accelerated sulphur or sulphur-donor systems, isocyanate systems, reactive melamine, formaldehyde and (optionally halogenated) phenol-formaldehyde resins and/or reactive phenolic resin systems or diisocyanate crosslinking systems with the corresponding activators, expoxidized polyester resins and acrylate resins, and also combinations of these.

The crosslinkers are activated preferably at temperatures above 50° C., in particular at temperatures of 100° C. to 160° C., very preferably at temperatures of 110° C. to 140° C. Thermal excitation of the crosslinkers may also take place by means of IR rays or high-energy alternating fields.

A suitable adhesive is one based on acrylate hotmelt, on solvent or on water, it being possible for the former to have a K value of at least 20, in particular more than 30, and obtainable by concentrating a solution of such an adhesive to give a system which can be processed as a hotmelt.

Concentration may take place in appropriately equipped tanks or extruders; in the case of accompanying devolatilization, a devolatilizing extruder is particularly preferred.

An adhesive of this kind is set out in DE 43 13 008 A1, whose content is hereby incorporated by reference to be part of this disclosure and invention.

Alternatively the acrylate hotmelt-based adhesive can also be chemically crosslinked.

In a further embodiment the self-adhesives used are copolymers of (meth)acrylic acid and the esters thereof having 1 to 25 carbon atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content should be below 1% by weight.

One adhesive which proves to be suitable is a low molecular mass acrylate hotmelt pressure-sensitive adhesive of the kind carried under the name acResin UV or Acronal®, especially Acronal® DS 3458, by BASF. This low-K-value adhesive acquires its application-compatible properties by means of a concluding, radiation-induced chemical crosslinking.

Finally it may be mentioned that polyurethane-based adhesives are also suitable.

A single-sided adhesive tape can be used with particular advantage, the adhesive coatweight being preferably 40 to 100 g/m², more preferably between 60 to 80 g/m².

The backing material may additionally and preferably carry on its reverse face a release coating for improving the unwind, or a corona treatment.

It is advantageous to use a primer layer between backing film and adhesive in order to enhance the adhesion of the adhesive to the film and hence to improve residue-free removability after the application.

Descriptions of the adhesives commonly used for adhesive tapes, and also of release coatings and primers, are found for example in the “Handbook of Pressure Sensitive Adhesive Technology” by Donatas Satas (van Nostrand, 1989).

The adhesive tapes have running lengths in particular of 1000 to 30 000 m. Roll widths commonly selected are 10, 15, 19, 25 and 30 mm.

Filaments added to the backing material are high-strength fibres, folded yarns, folded union yarns or threads with low breaking extension.

The individual filaments are preferably continuous filaments and/or have a linear density of between 4 and 8 dtex, preferably 5 dtex. In one advantageous embodiment all of the filaments are continuous filaments.

In one preferred embodiment there are between 1 and 5 filaments per centimetre width in the backing material, in particular between 1 and 3.

It has proved to be advantageous additionally if the individual filaments are disposed regularly in one alignment parallel to the backing material or at most in three alignments parallel to the backing material.

Within each alignment the filaments are disposed in parallel alongside one another.

The filaments may be composed of organic or inorganic materials: thus, for example and preferably, of glass, carbon, combinations of both fibre types, aramid fibres or special polyamides, or of drawn polymer fibres such as polyester fibres, polypropylene fibres, polyethylene fibres, and additionally the reinforcing fibres may be at least partly coloured in order to make the backing material more visually appealing. In this way it is readily possible to provide visual differentiation of the reinforced backings. Particularly appropriate for this purpose are coloured glass threads or polymer threads.

The backing material, further, is preferably laminated with the filaments. The filaments should be firmly connected to the backing material. This can be done by direct incorporation or insetting of the fibres, threads, folded yarns or folded union yarns into the backing, such as by weaving them in the case of wovens, knitting them in the case of knits, or embedding or inserting them in the case of the production process of films, gels or foam materials and nonwovens.

Alternatively the filaments can be connected subsequently to the backing; for example, mention may be made of their welding or lamination to a corresponding connection layer.

With further preference the backing material can be torn by hand vertically with respect to the orientation of the reinforcement and/or in the direction of the reinforcement.

The number of attached or introduced threads and/or high-strength fibres depends primarily on the particular end use envisaged and on the target ultimate tensile stress strength and ultimate tensile stress extension of the backing material and hence of the adhesive tape, on its own nature, and on the respective strength of the fibres and threads themselves, and may therefore be varied within relatively wide limits.

With increasing reinforcement, the backing withstands greater stress and load. Additionally, the reinforcements are preferably inserted purposively in accordance with the direction of stress on the backing material—that is primarily, in lengthwise direction. However, if it is more appropriate, they can also extend additionally in transverse or oblique direction or, for example, in a curve, spiral or zigzag formation, or irregularly. In this context it may be desirable and achievable for the backing material to be able to be torn into by hand perpendicularly with respect to the orientation of the reinforcement and/or in the direction of the orientation.

In one advantageous embodiment of the subject matter of the invention the backing material features the following combinations of properties:

| | |
|---|---|
| 100% of the filaments made from glass | |
| Basis weight 39 g/m² | |
| Number of filaments in lengthwise direction: | 90 per dm |
| Number of filaments in transverse direction: | 25 per dm |
| => Mesh: | 1.11 × 4 mm |
| Tensile strength: | 950 N/5 cm in |
| | lengthwise direction |
| | 250 N/5 cm in |
| | transverse direction |
| Extension lengthwise and transversely | |
| 1.5% in each case | |

The incisions on at least one long edge may be disposed irregularly and may be of differing depth.

Each individual incision in the margin of the adhesive tape, in other words at the long edge, may have a non-linear, curve-shaped or serrated profile with local minima and local maxima, and is described by means of a width and an associated depth. The depth of an incision is denoted as the distance between two straight lines running parallel in the lengthwise direction of the adhesive tape, with one straight line cutting a minimum and the second a maximum.

Arranged in a row, the incisions may produce a preferably regular corrugated form without, or with only short, linear regions between points and bases of each individual incision, producing a profile which equates to a sinusoidal curve.

The serration employed preferably is composed of a sequence of serrate notches which in one advantageous embodiment are identical and which are present on at least one of the long edges of the adhesive tape. The notches may in particular be rounded off at the point protruding into the backing of the adhesive tape; in other words, a radius. This is of course also true for the outwardly pointing points between the individual notches, which can also be rounded off.

The frequency of the incisions/notches is preferably at least 1/cm, preferably 10 to 30/cm, very preferably 15 to 25/cm, it being possible for the notches likewise to be disposed irregularly and to be of differing depth.

In one further advantageous embodiment of the invention there are incisions/notches which have a depth of 15 to 100 μm.

The serration is produced by methods which are elucidated below and using machinery which is elucidated below:

The longitudinal slitting of the adhesive-coated film web (film a and b) was carried out using rotating crush cutting knives which are designed in terms of their cutting geometry as zig-zag knives.

| | |
|---|---|
| Zig-zag knife | 0.2 mm |
| Number of teeth: | 604 |
| Cutting phase angle: | 90° |
| Tooth width: | 0.2 mm |
| Cutting face width: | <0.05 mm |

### BRIEF DESCRIPTION OF DRAWINGS

FIGS. 1 and 2 show the crush cutting knife 1 used. The knife 1 has 604 teeth 2. The cutting phase angle α is 90°. The tooth width A is shown in the table below; the cutting face width B is less than 0.05 mm.

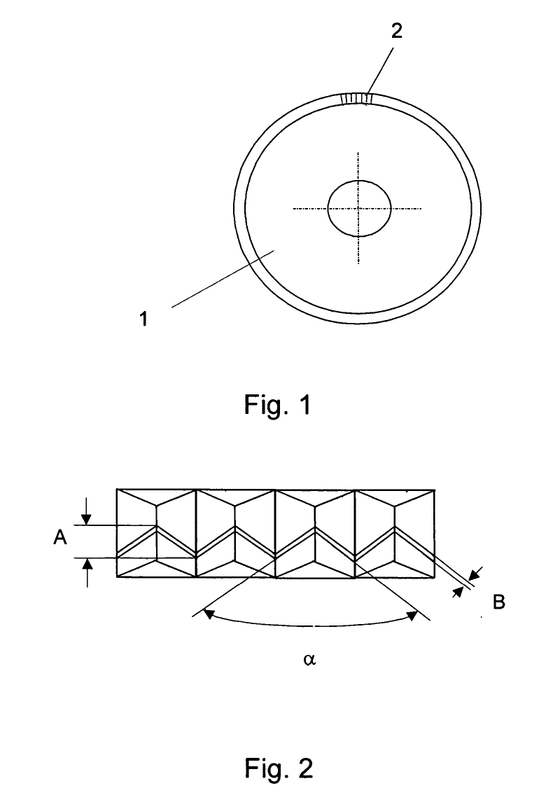

| | | Ultimate | |
|---|---|---|---|
| | | tensile stress | Breaking |
| | | strength | extension |
| | Tooth width A | [N/cm] | [%] |
| 2a | Slit cut | 273 | 5.3 |
| 2b | Crush cut | 276 | 5.4 |
| 2c | Serrations 1 mm | 270 | 5.2 |
| 2d | Serrations 0.5 mm | 273 | 5.3 |
| 2e | Serrations 0.2 mm | 278 | 5.3 |
| 2f | Serrations 2.2 mm | 235 | 5.2 |

The notches prevent thread pullout during mechanical processing of the adhesive tape by severing, for each long edge, not more than one filament aligned substantially parallel to the cut edge.

On the other hand, the adhesive tape is reinforced by means of filaments, so that, in spite of the weakening of the backing material as a result of the serration, there is no resulting detriment to the mechanical properties such as breaking strength and ultimate tensile stress strength.

1. Adhesive tape having a backing material applied to at least one side of which is an adhesive and whose strength in lengthwise direction is reinforced by integrated fibres or filaments, wherein the adhesive tape on at least one long edge has incisions severing per long edge not more than one filament aligned substantially parallel to the cut edge.

2. Adhesive tape according to claim 1, wherein the individual filaments are continuous filaments and/or have a linear density of between 4 and 8 dtex.

3. Adhesive tape according to claim 1, wherein the individual filaments are disposed in one to three parallel alignments.

4. Adhesive tape according to claim 1, wherein the individual filaments are composed of high-strength fibres of low breaking extension or of drawn polymer fibres.

5. Adhesive tape according to claim 1, wherein there are between 1 and 5 filaments per centimetre width in the backing material.

6. Adhesive tape according to claim 1, wherein the backing material is reinforced by an open filament fabric.

7. Adhesive tape according to claim 1, wherein the backing material has a thickness of 10 to 100 μm.

8. Adhesive tape according to claim 1, wherein the support has a thickness of up to 50 μm.

9. Adhesive tape according to claim 1, wherein the application of adhesive to the backing material amounts to between 40 to 100 g/m².

10. A method of bundling, packaging or palletizing, which comprises bundling, packaging or palletizing with the adhesive tape of claim 1.

11. A method for reinforcing paper, corrugated board or solid board, which comprises reinforcing same with the adhesive tape of claim 1.

12. The adhesive tape of claim 1, wherein said incisions are serrations.

13. The adhesive tape of claim 4, wherein said individual filaments are composed of glass fibres, carbon fibres, polyester fibres, polypropylene fibres, polyethylene fibres, polyamide fibres or aramid fibres.

14. The adhesive tape of claim 5, wherein there are between 1 and 3 filaments per centimetre width in the backing material.

15. The adhesive tape of claim 7, wherein said thickness is 20 to 40 μm.

16. The adhesive tape of claim 9, wherein said adhesive is applied in an amount between 60 to 80 g/m².
